(19) United States
(12) Patent Application Publication
(10) Pub. No.: US 2024/0180222 A1
(43) Pub. Date: Jun. 6, 2024

(54) A COMPOSITION AND METHOD OF USE THEREOF

(71) Applicant: Flavour Creations PTY Ltd, Acacia Ridge, Queensland (AU)

(72) Inventor: Bernadette Eriksen, Acacia Ridge (AU)

(21) Appl. No.: 18/553,499

(22) PCT Filed: Apr. 6, 2022
(86) PCT No.: PCT/AU2022/050303

§ 371 Date: Sep. 29, 2023

(30) Foreign Application Priority Data
Apr. 6, 2021 (AU) 2021901004

(51) Int. Cl. A23L 29/269; A23L 5/10; A23L 29/238; A23L 29/25

(52) U.S. Cl. CPC A23L 29/272; A23L 5/10; A23L 29/238; A23L 29/25

(57) ABSTRACT

The present invention relates to thickened nutritional products for dysphagia patients. In one form, a composition for thickening a nutritional product to make the nutritional product suitable for consumption by dysphagia patients is provided. The composition includes by wt. % of the composition between about 0.1% to about 3.0% of xanthan gum: between about 0.1% to about 1.0% of acacia gum: and between about 0.001% to about 0.01% of gellan gum, and the composition is substantially free of starch.

### TECHNICAL FIELD

The present invention relates to thickened nutritional products for dysphagia patients. In particular, the present invention concerns a composition and methods for thickening nutritional products.

### BACKGROUND

Dysphagia is a medical term for swallowing difficulties. Some people with dysphagia have difficulties swallowing certain foods or liquids, while other people with dysphagia cannot swallow at all. Generally, for people with dysphagia eating is a challenge often resulting in a reluctance to eat or drink due to fear of choking. This, in turn, may lead to malnutrition and dehydration.

Typically, dysphagia occurs when there is problem with the neural control, or the structures involved in any part of the swallowing process. For example, weak tongue or cheek muscles may make it hard to move food around in the mouth for chewing. Similarly, a stroke or other nervous system disorder may make it difficult to start the swallowing process, i.e., a stimulus that allows food and liquids to move safely through the throat. Further, dysphagia can occur when weak throat muscles, such as after cancer surgery, cannot move food toward the stomach. Lastly, dysphagia may result from disorders of the oesophagus.

Generally, dysphagia management involves several techniques, including the thickening of foods and liquids to slow a rate of consumption. Thickening provides better bolus control, greater oral stimulation and, when swallowed, it affords the epiglottis time to close thereby preventing undesired and potentially fatal aspiration of the foods and liquids into the lungs.

Starch is generally used to thicken foods and liquids for dysphagia patients due to its texture modification properties, cost price and taste. The use of other hydrocolloids and thickening agents has proven problematic due to charge interactions and excessive chemical reactivity with other ingredients. For example, foods and liquids containing other thickening and gelling hydrocolloids will often cause certain proteins to destabilize, flocculate and/or separate into unappealing layers.

A problem in general with starch-based thickeners is that they lack stability, particularly during consumption by a dysphagia patient. Specifically, amylase in the saliva of the patient degrades the starch thereby causing foods and liquids to lose their thickened texture and revert to a liquid consistency and again pose a serious aspiration risk.

Thickening products for dysphagia patients have been previously developed that claim greater stability.

For example, WO2006/054886 is directed to a thickening composition for thickening nutritional products for dysphagia patents. However, the thickening composition, apart from containing other hydrocolloids and thickening agents, still contains starch and is thus ultimately unstable when consumed by a dysphagia patient.

A problem in general with prior art thickening compositions and dysphagia products is that they ignore the time taken by dysphagia patients to consume foods and liquids. For example, it is common for partially consumed dysphagia food to be covered and refrigerated for later consumption. Further, it is common for these partially consumed foods and liquids to be initially contaminated with amylase through repeated lip contact (i.e., sipping of liquids) and via saliva deposited on eating utensils that are repeatedly dipped into foods when scooping and stirring and placed in a patient's mouth. Accordingly, even if a prior art thickening composition exhibits strong initial amylase resistance, the thickened foods or liquids continues to degrade while in storage and pose a serious future aspiration risk when later consumed by the dysphagia patient.

It will be clearly understood that, if a prior art publication is referred to herein, this reference does not constitute an admission that the publication forms part of the common general knowledge in the art in Australia or in any other country.

### SUMMARY OF INVENTION

Embodiments of the present invention provide a composition for thickening a nutritional product, a thickened nutritional product and methods of preparation and use thereof, which may at least partially address one or more of the problems or deficiencies mentioned above or which may provide the public with a useful or commercial choice.

According to a first aspect of the present invention, there is provided a composition for thickening a nutritional product to make the product suitable for consumption by dysphagia patients, said composition including by weight % of a ready to consume said product:
between about 0.1% to about 3.0% of xanthan gum;
between about 0.1% to about 1.0% of acacia gum; and
between about 0.001% to about 0.01% of gellan gum,
wherein the composition is substantially free of starch.

According to a second aspect of the present invention, there is provided a thickened nutritional product including a composition for thickening according to the first aspect, wherein the thickened nutritional product is substantially free of starch.

Advantageously, embodiments of the present invention provide a thickening composition that is substantially free of starch and therefore substantially unsusceptible to the effects of amylase. Accordingly, a nutritional product thickened with the composition reliably provides a constant viscosity, even when consumed in intervals and over an extended period.

As used herein, the term “substantially free of starch” means that the composition and/or nutritional product contains an amount of starch incapable of altering the viscosity profile of the composition and/or nutritional product when exposed to amylase. Typically, the term means the composition and/or product contains less than 5 wt. %, less than 4 wt. %, less than 3 wt. %, less than 2 wt. %, less than 1 wt. % starch or even 0 wt. % starch.

As used herein, the term “nutritional product” encompasses a food, liquid in appearance, entirely or in part based on water, a liquid nutrient, food containing unbound liquid, liquid medication, or food. The nutritional product may provide nutritionally effective amounts of protein, carbohydrates and/or fat.

The nutritional product may include at least one of milk, carbonated beverages, coffee, tea, juice, water, cordial, acidified milk/juice beverages (“smoothies”), liquid deserts, liquid medications, alcohol (beer, wine, or mixed drinks with less than about 20% alcohol), nutritional supplements, mixtures thereof and the like and or a soup, broth, stew, food puree and the like.

As used herein, the term “juice” includes puree, fruit juices, including orange juice, vegetable juice and apple juice strained and unstrained, concentrated, and fresh.

As used herein and unless otherwise specified, the term “xanthan gum” includes xanthan gum and clarified xanthan gum in all different powder forms and mesh sizes.

As used herein and unless otherwise specified, the term “gellan gum” includes native gellan gum, deacetylated gellan gum and clarified gellan gum.

As used herein and unless otherwise specified, the term “acacia gum” includes gum from Acacia senegal and Vachellia seyal as well as from Combretum, Albizia or some other genus.

Suitably, the composition is a liquid, semi-liquid or otherwise viscous or gelled composition, although a powder composition is also envisaged. Preferably, the composition is an aqueous composition. More preferably, the composition is provided in a ready to consume form.

Suitably, the composition may thicken a nutritional product to a desired consistency to facilitate consumption of the thickened nutritional product by a patient having dysphagia.

In some embodiments, the composition includes a non-substantial amount as relates to thickening of at least one component selected from the group consisting of acids, bases, emulsifiers, fibres, preservatives, chelating agents, flavours, colours, vitamins, minerals, and sweeteners.

In some embodiments, the composition may include at least one component selected from the group consisting of sodium, potassium and calcium salts (e.g., sodium citrate, potassium citrate), propylene glycol alginate, guar gum, locust bean gum, tara gum, konjac, agar, sodium alginate, potassium alginate, pectins and/or pectates, carrageenans, sodium caseinate, calcium caseinate, milk powder(s), collagen sources, sorbic acid, tartaric acid, phosphoric acid, potassium sorbate, carrageenans, methylcellulose, sodium carboxymethylcellulose, hydroxypropyl cellulose, hydroxypropyl methyl cellulose, and microcrystalline cellulose.

In some embodiments, the composition may include one or more soluble and/or colloidally dispersible carbohydrates. The one or more soluble and/or colloidally dispersible carbohydrates may be selected from the group consisting of glucose, fructose, galactose, sucrose, lactose, maltose, pectins, low-methoxy pectin, carrageenans, methylcellulose, sodium carboxymethylcellulose, hydroxypropyl cellulose, hydroxypropyl methyl cellulose, and microcrystalline cellulose.

In some embodiments, the composition may include at least one component selected from the group consisting of tara gum, locust bean gum, gelatins, sodium citrate, potassium citrate, sweeteners, colourants, flavours, emulsifiers, and preservatives.

In some embodiments, the composition includes by weight % of a ready to consume product between about 0.1% to about 3.0% xanthan gum, between about 0.1% to about 1.0% acacia gum, between about 0.001% to about 0.1% gellan gum, between about 0.001% to about 0.01% tara gum, water, and optionally a non-substantial amount as relates to thickening of at least one component selected from the group consisting of acids, bases, emulsifiers, preservatives, chelating agents, flavours, colours, vitamins, minerals, sweeteners, and insoluble foods.

In some embodiments, the composition may include by weight % of a ready to consume product between about 0.1% to about 2.5% xanthan gum, preferably between about 0.2% to about 2.0% xanthan gum.

In some embodiments, the composition may include by weight % of a ready to consume product between about 0.1% to about 0.75% acacia gum, preferably between about 0.1% to about 0.5% acacia gum, more preferably about 0.25% acacia gum.

In some embodiments, the composition may include by weight % of a ready to consume product between about 0.001% to about 0.05% gellan gum, preferably between about 0.001% to about 0.01% gellan gum, more preferable between about 0.005% to about 0.0075% gellan gum. In preferred embodiments, the gellan gum is high acyl gellan gum.

In some embodiments, the composition may include by weight % of a ready to consume product between about 0.001% to about 0.005% tara gum, preferably between about 0.001% to about 0.003% tara gum.

In some embodiments, the composition may include by weight % of a ready to consume product between about 0.001% to about 0.75% locust bean gum, typically between about 0.001% to about 0.01% locust bean gum, preferably between about 0.001% to about 0.005% locust bean gum.

In some embodiments, the composition may include by weight % of a ready to consume product between about 0.001% to about 0.75% guar gum, typically between about 0.001% to about 0.01% guar gum, preferably between about 0.001% to about 0.005% guar gum.

In some embodiments, the composition is packaged in a tote, a bin, a pouch, a bucket, a cup, a bag, or a syringe to be added to the nutritional product.

In other embodiments, the composition includes the nutritional product.

In some embodiments, said composition with or without said nutritional product is heat processed, preferably heated under pressure. The heat processing is important to achieve a desired rheological function of the composition with or without the nutritional product as well as to sterilise and provide improved shelf stability.

In some embodiments, said composition with or without said nutritional product is pasteurised to provide improved shelf stability.

In some embodiments, said composition with or without said nutritional product is at least partially prepared and supplied under cold chain conditions.

According to a third aspect of the present invention, there is provided a method of preparing a thickened nutritional product including:
mixing the composition according to the first aspect with a nutritional product to obtain the thickened nutritional product.

The method may include one or more features or characteristics of the composition and nutritional product as hereinbefore described.

In some embodiments, the mixing may include combining together parts of the nutritional product and/or the composition in specific sequences. For example, depending on the nutritional product, nutritional elements may be added before some functional elements.

In some embodiments, the mixing may include at least one of cooking, blending, and emulsifying the composition and the nutritional product or components thereof together to obtain the thickened nutritional product.

In some embodiments, the method may further include at least one of pressure cooking and/or pasteurising the thickened nutritional product, preferably such that the product is sterile.

In some embodiments, the method may further include packaging and sealing the thickened nutritional product.

In some embodiments, said thickened nutritional product is prepared and supplied under cold chain conditions.

According to a fourth aspect of the present invention there is provided use of a composition including xanthan gum, acacia gum and gellan gum for preparing a nutritional product substantially free of starch for treatment of dysphagia patients.

According to a fifth aspect of the present invention there is provided a method of treatment of dysphagia, said method including administering a composition including xanthan gum, acacia gum, gellan gum and a nutritional product to a patient in need thereof, wherein the composition and the nutritional product are substantially free of starch.

The use and the method of the fourth and fifth aspects may include one or more characteristics of the composition and nutritional product as hereinbefore described.

In some embodiments, the composition and the nutritional product are mixed and administered as a thickened nutritional product.

In some embodiments, the mixing may further include at least one of cooking, blending, sterilising, and emulsifying the composition and the nutritional product or components thereof together to obtain the thickened nutritional product, typically at least one of pressure cooking or pasteurising the thickened nutritional product prior to administering.

Any of the features described herein can be combined in any combination with any one or more of the other features described herein within the scope of the invention.

The reference to any prior art in this specification is not and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of Invention in any way. The Detailed Description will make reference to a number of drawings as follows:

FIG. 1 is a table showing raw viscosity data of various nutritional products inoculated with amylase over a period;

FIGS. 2A and 2B are graphs showing viscosity versus time for nutritional product samples containing starch and inoculated with amylase using different inoculation methodologies, respectively;

FIGS. 3A and 3B are graphs showing viscosity versus time for other nutritional product samples containing starch and inoculated with amylase using different inoculation methodologies, respectively;

FIG. 4 is a graph showing viscosity versus time for a nutritional product sample containing starch inoculated with amylase using a single inoculation methodology;

FIGS. 5A to 5E are photographs showing product samples prepared with varying concentrations of acacia gel;

FIGS. 6A to 61 are photographs showing product samples prepared with an expanded range of acacia gel; and

FIGS. 7A to 7D are photographs showing product samples prepared with varying concentrations of gellan gum.

### DETAILED DESCRIPTION

The present invention is predicated, at least in part, on the finding that removal of all starch-based thickeners will result in a composition that is substantially resistant against amylase activity.

Further, the present invention is at least in part predicated on the finding that when xanthan gum and gellan gum are mixed with acacia gum a composition is obtained that complies with all essential properties of a thickener suitable for dysphagia patients. The combination of gums gives an ideal viscosity profile.

Without wishing to be bound by any particular theory, the inventor postulates that the acacia gum in the composition shields proteins in the nutritional product from excessive interactions with the gellan gum and the xanthan gum, both of which are known destabilisers of proteins. Accordingly, the acacia gum in the composition enables the xanthan gum and gellan gum to be distributed more freely amongst protein matrices of the nutritional product where the gums can demonstrate their full rheological effect without causing protein instability. The resulting composition is surprisingly stable against various textural and visible defects while still delivering the preferred swallowability and acceptable organoleptics for dysphagia patients.

Unless defined otherwise, all technical and scientific terms used herein have the same meaning as would be commonly understood by those of ordinary skill in the art to which this invention belongs.

In a first aspect of the invention, a composition for thickening a nutritional product is provided to make the product suitable for consumption by dysphagia patients, said composition including by weight % of a ready to consume said product:
between about 0.1% to about 3.0% of xanthan gum;
between about 0.1% to about 1.0% of acacia gum; and
between about 0.001% to about 0.01% of gellan gum,
wherein the composition is substantially free of starch.

In a second aspect of the invention, a thickened nutritional product is provided including a composition for thickening according to the first aspect, wherein the thickened nutritional product is substantially free of starch.

Suitably, the composition is a liquid composition, preferably an aqueous composition.

Suitably, the composition thickens the nutritional product to a desired consistency to facilitate consumption of the thickened nutritional product by a patient having dysphagia.

Typically, the composition further includes tara gum. Any suitable quantity of tara gum may be used. For example, the composition may include by weight % of the ready to consume product between about 0.001% to about 0.005% tara gum, preferably between about 0.001% to about 0.003% tara gum.

Again, without wishing to be bound by any particular theory, the inventor postulates that the tara gum functions as a textural modifier and controls long flowing (stringy) textures enabling the creation of short textures that will remain in place on a fork or the like and “shapeable”. The tara gum is of most use in high viscosity dysphagia preparations, such as, e.g., IDDSI level 4 products. However, it is also believed to play a significant role is lower viscosity products, such as, e.g., IDDSI level 1 and 2 products.

In preferred embodiments, the composition includes by weight % of a ready to consume product between about 0.2% to about 2.0% xanthan gum, between about 0.1% to about 0.5% acacia gum, between about 0.001% to about 0.01% gellan gum, between about 0.001% to about 0.003% tara gum, water, and optionally a non-substantial amount as relates to thickening of at least one component selected from the group consisting of acids, bases, emulsifiers, preservatives, chelating agents, flavours, colours, vitamins, minerals, sweeteners, and insoluble foods.

In embodiments, the composition further includes the nutritional product. The nutritional product may include at least one of milk, soda, coffee, tea, juice, water, cordial, smoothie, liquid desert, liquid medication, alcohol (beer, wine, or mixed drinks with less than about 20% alcohol), nutritional supplements, mixtures thereof and the like and or a soup, broth, or food puree and the like.

In embodiments, the composition further includes sodium citrate, potassium citrate, chelating agents, sweeteners, colourants, flavours, vitamins, minerals, emulsifiers, and preservatives. It is understood that such components will likely be present in minor amounts and concentrations, i.e., a non-substantial amount as relates to thickening.

In some embodiments, the composition further includes at least one component selected from the group consisting of sodium citrate, potassium citrate, propylene glycol alginate, guar gum, locust bean gum, tara gum, carob bean gum, konjac, agar, sodium alginate, potassium alginate, low-methoxy pectin, carrageenan, sodium caseinate, calcium caseinate, skim milk powder, sorbic acid, tartaric acid, phosphoric acid, potassium sorbate, sodium carboxymethylcellulose, hydroxypropyl cellulose, hydroxypropyl methyl cellulose, and microcrystalline cellulose.

Any suitable sweetener may be used as known to those skilled in the art. For example, the composition may include a sweetener selected from the group consisting of allulose, aspartame, sucralose, neotame, acesulfame potassium, cyclamate, mogrosides, stevia, saccharin, advantame, sorbitol, xylitol, lactitol, glycerol, ethylene glycol, erythritol, threitol, arabitol, ribitol, mannitol, galctitol, fucitol, iditol, inositol, volemitol, isomalt, maltitol and other sugar alcohols or polyols.

Any suitable emulsifier may be used as known to those skilled in the art. For example, the composition may include at least one emulsifier selected from the group consisting of acacia gum, soy lecithin, mono- and diglycerides, sodium stearoyl lactylate, and DATEM.

Any suitable fibre may be used as known to those skilled in the art. For example, the composition may include at least one fibre selected from the group consisting of carrageenans, methylcellulose, sodium carboxymethylcellulose, hydroxypropyl cellulose, hydroxypropyl methyl cellulose, and microcrystalline cellulose.

Any suitable preservative may be used as known to those skilled in the art. For example, the composition may include at least one preservative selected from the group consisting of sorbic acid, salts of sorbic acid, benzoic acid, salts of benzoic acid, sulphur dioxide, sulphides, propionic acid, and salts of propionic acid.

Likewise, any suitable colourants and flavours may be used as known to those skilled in the art.

In embodiments, said composition with or without said nutritional product is heated under pressure to provide shelf stability.

In other embodiments, said composition with or without said nutritional product is pasteurised to provide shelf stability.

In a third aspect of the invention, a method of preparing a thickened nutritional product is provided, said method including:
mixing the composition according to the first aspect with a nutritional product.

The composition and the nutritional product may be as described in the first and/or second aspects.

The mixing may include at least one of cooking, blending, and emulsifying the composition and the nutritional product or components thereof together to obtain the thickened nutritional product.

The method may further include at least one of pressure cooking and pasteurising the thickened nutritional product.

In some embodiments, the method may further include packaging and sealing the thickened nutritional product.

In a fourth aspect of the invention, use of a composition including xanthan gum, acacia gum and gellan gum for preparing a nutritional product substantially free of starch for treatment of dysphagia patients.

The composition and the nutritional product may be as described in the first and/or second aspects.

Preferably, wherein the composition thickens the nutritional product to a desired consistency to facilitate consumption of the thickened nutritional product by dysphagia patients.

In a fifth aspect of the invention, a method of treatment of dysphagia is provided, said method including administering a composition including xanthan gum, acacia gum, gellan gum and a nutritional product to a patient in need thereof, wherein the composition and the nutritional product are substantially free of starch.

The composition and the nutritional product may be as described in the first and/or second aspects.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

### EXAMPLES

### Example 1: White Coffee Drink

A white coffee drink according to the present invention for consumption by dysphagia patients is prepared with the following ingredients and according to the following viscosity profiles. The ingredients are mixed in an aqueous composition and pasteurised.

| | Low | Medium | High |
|---|---|---|---|
| | Viscosity | Viscosity | Viscosity |
| | Profile | Profile | Profile |
| Ingredients | (wt. %) | (wt. %) | (wt. %) |
| Instant coffee | 1.25 | 1.15 | 1.25 |
| Full cream milk powder | 2.0 | 2.0 | 2.0 |
| Sodium Citrate | 0.25 | 0.38 | 0.4 |
| Glyceryl mono stearate | 0.05 | 0.05 | 0.1 |
| Potassium citrate | 0.4 | 0.3 | 0.4 |
| Sugar (white refined) | 1.0 | 1.0 | 1.0 |
| Titanium dioxide | 0.05 | 0.05 | 0.05 |
| Tara gum | 0.001 | 0.001 | 0.001 |
| Xanthan gum | 0.9 | 1.3 | 2.0 |
| Gellan gum | 0.001 | 0.001 | 0.001 |
| Acacia gum | 0.001 | 0.001 | 0.001 |
| Coffee flavour | 0.0 | 0.3 | 0.4 |

### Example 2: Creamy Chocolate Drink

A creamy chocolate drink according to the present invention for consumption by dysphagia patients is prepared with the following ingredients and according to the following viscosity profiles. The ingredients are mixed in an aqueous composition and pasteurised.

| | Low | Medium | High |
|---|---|---|---|
| | Viscosity | Viscosity | Viscosity |
| | Profile | Profile | Profile |
| Ingredients | (wt. %) | (wt. %) | (wt. %) |
| Full cream milk powder | 5.0 | 5.0 | 5.0 |
| Sodium Citrate | 0.3 | 0.2 | 0.3 |
| Glyceryl mono stearate | 0.2 | 0.2 | 0.2 |
| Sugar (white refined) | 8.0 | 8.0 | 8.0 |
| Tara gum | 0.001 | 0.001 | 0.001 |
| Xanthan gum | 0.4 | 0.65 | 1.5 |
| Gellan gum | 0.03 | 0.045 | 0.001 |
| Acacia gum | 0.1 | 0.25 | 0.001 |
| Calcium Caseinate | 1.5 | 1.5 | 1.8 |
| Sodium hexametaphosphate | 0.1 | 0.1 | 0.0 |
| Non-dairy butter flavour | 0.15 | 0.15 | 0.15 |
| Cocoa | 2.0 | 2.0 | 2.0 |
| Chocolate flavour | 0.240 | 0.304 | 0.304 |

### Example 3: Creamy Strawberry Drink

A creamy strawberry drink according to the present invention for consumption by dysphagia patients is prepared with the following ingredients and according to the following viscosity profiles. The ingredients are mixed in an aqueous composition and pasteurised.

| | Low | Medium | High |
|---|---|---|---|
| | Viscosity | Viscosity | Viscosity |
| | Profile | Profile | Profile |
| Ingredients | (wt. %) | (wt. %) | (wt. %) |
| Full cream milk powder | 5.9 | 5.9 | 5.0 |
| Sodium citrate | 0.1 | 0.1 | 0.1 |
| Glyceryl mono stearate | 0.2 | 0.2 | 0.2 |
| Sugar (white refined) | 7.0 | 7.0 | 7.0 |
| Xanthan gum | 0.58 | 0.9 | 3.2 |
| Gellan gum | 0.048 | 0.05 | 0.001 |
| Acacia gum | 0.288 | 0.300 | 0.001 |
| Sodium hexametaphosphate | 0.05 | 0.05 | 0.0 |
| Calcium caseinate | 2.0 | 0.0 | 2.0 |
| Strawberry flavour | 0.54 | 0.66 | 1.0 |
| Vanilla flavour | 0.07 | 0.07 | 0.07 |
| Polyoxyethylene (20) | 0.25 | 0.25 | 0.0 |
| sorbitan monostearate | | | |
| Carmine | 0.1 | 0.1 | 0.1 |

### Example 3: Protein Caramel Drink

A protein caramel drink according to the present invention for consumption by dysphagia patients is prepared with the following ingredients and according to the following viscosity profiles. The ingredients are mixed and retorted in an aqueous composition.

| | Low | Medium | High |
|---|---|---|---|
| | Viscosity | Viscosity | Viscosity |
| | Profile | Profile | Profile |
| Ingredients | (wt. %) | (wt. %) | (wt. %) |
| Sodium citrate | 0.220 | 0.220 | 0.220 |
| Potassium citrate | 0.350 | 0.350 | 0.350 |
| Sugar (white refined) | 15.0 | 15.0 | 15.0 |
| Titanium dioxide | 0.055 | 0.055 | 0.055 |
| Xanthan gum | 0.4 | 0.8 | 1.0 |
| Gellan gum | 0.02 | 0.02 | 0.001 |
| Acacia gum | 0.04 | 0.04 | 0.001 |
| Calcium Caseinate | 4.25 | 4.25 | 4.25 |
| Sodium hexametaphosphate | 0.05 | 0.05 | 0.05 |
| Microcrystalline cellulose | 0.35 | 0.35 | 0.35 |
| Tetrasodium pyrophosphate | 0.05 | 0.05 | 0.05 |
| Maltodextrin | 9.250 | 9.250 | 9.250 |
| Caramelised sugar (dark) | 0.125 | 0.125 | 0.125 |
| Soluble dietary fibres | 1.860 | 1.860 | 1.860 |
| Collagen | 4.20 | 4.20 | 4.20 |
| Vanilla flavour | 0.1 | 0.1 | 0.1 |
| Caramel flavour | 0.31 | 0.31 | 0.31 |
| Golden syrup flavour | 0.15 | 0.15 | 0.15 |

### Example 4: Chocolate Nutritional Food

A chocolate nutritional product according to the present invention for consumption by dysphagia patients is prepared with the following ingredients and according to the following viscosity profiles. The ingredients are mixed and retorted in an aqueous composition.

| | Low | Medium | High |
|---|---|---|---|
| | Viscosity | Viscosity | Viscosity |
| | Profile | Profile | Profile |
| Ingredients | (wt. %) | (wt. %) | (wt. %) |
| Sodium citrate | 0.3 | 0.1 | 0.15 |
| Glyceryl mono stearate | 0.1 | 0.0 | 0.1 |
| Potassium citrate | 0.4 | 0.22 | 0.22 |
| Sugar (white refined) | 10.0 | 10.0 | 10.0 |
| Titanium dioxide | 0.11 | 0.11 | 0.11 |
| Xanthan gum | 0.2 | 0.5 | 1.0 |
| Gellan gum | 0.03 | 0.1 | 0.001 |
| Acacia gum | 0.05 | 0.45 | 0.001 |
| Sodium hexametaphosphate | 0.05 | 0.05 | 0.05 |
| Cocoa | 1.5 | 1.5 | 1.5 |
| Microcrystalline cellulose | 0.4 | 0.4 | 0.4 |
| Tetrasodium pyrophosphate | 0.05 | 0.05 | 0.0 |
| Maltodextrin | 13.0 | 12.75 | 12.75 |
| Soluble dietary fibres | 1.8 | 1.8 | 1.8 |
| Collagen | 6.13 | 6.1 | 6.15 |
| Whey protein hydrolysate | 2.160 | 2.160 | 2.160 |
| chocolate flavour | 0.42 | 0.46 | 0.52 |
| Polyoxyethylene (20) | 0.250 | 0.0 | 0.0 |
| sorbitan monostearate | | | |
| Caramel flavour | 0.1 | 0.1 | 0.1 |

### Example 5: Iced Coffee Drink

An iced coffee drink according to the present invention for consumption by dysphagia patients is prepared with the following ingredients and according to the following viscosity profiles. The ingredients are mixed and retorted in an aqueous composition.

| | Low | Medium | High |
|---|---|---|---|
| | Viscosity | Viscosity | Viscosity |
| | Profile | Profile | Profile |
| Ingredients | (wt. %) | (wt. %) | (wt. %) |
| Potassium citrate | 0.0 | 0.0 | 0.22 |
| Sugar (white refined) | 7.7 | 7.7 | 7.7 |
| Titanium dioxide | 0.11 | 0.11 | 0.11 |
| Xanthan gum | 0.15 | 0.7 | 1.25 |
| Gellan gum | 0.15 | 0.025 | 0.001 |
| Acacia gum | 0.5 | 0.075 | 0.001 |
| Sodium hexametaphosphate | 0.055 | 0.055 | 0.055 |
| Microcrystalline cellulose | 0.25 | 0.25 | 0.3 |
| Tetrasodium pyrophosphate | 0.055 | 0.055 | 0.055 |
| Maltodextrin | 18.0 | 13.8 | 16.0 |
| Caramelised sugar (dark) | 0.12 | 0.12 | 0.12 |
| Soluble dietary fibres | 3.5 | 3.5 | 2.5 |
| Collagen | 5.95 | 5.95 | 6.6 |
| Whey protein hydrolysate | 2.16 | 2.16 | 2.16 |
| Coffee flavour | 0.45 | 0.55 | 0.70 |
| Polyoxyethylene (20) | 0.25 | 0.25 | 0.0 |
| sorbitan monostearate | | | |
| Caramel flavour | 0.2 | 0.2 | 0.2 |

### Example 6: Stability Studies

Objective—analyse the effect of amylase on the viscosity profile of various nutritional products.

Methodology—Five different types of nutritional product as shown in the table below were tested using a direct consumption and/or utensil methodology.

| Product | Grouping | Direct method | Utensil method |
|---|---|---|---|
| Creamy chocolate | Creamy strawberry, | Y | |
| 150 | banana dairy and | | |
| Creamy chocolate | coffee (150, 400 & | Y | Y |
| 400 | 900) | | |
| Creamy chocolate | | | Y |
| 900 | | | |
| Chocolate 150 | Iced coffee and | Y | |
| Chocolate 400 | caramel | Y | Y |
| Chocolate 900 | | | Y |
| Apple berry 400 | Apple berry | Y | Y |
| Apple berry 900 | | | Y |
| Pro lemon lime | Lemon lime | | Y |
| Smooth fruits | Smooth fruit plum | | Y |
| banana & mango | and apple | | |
| Vanilla custard | Chocolate and | | Y |
| | banana custards | | |

The direct consumption methodology entailed inoculating samples with amylase by directly sipping from a cup containing the sample every 2 minutes for a 20-minute period. Viscosity was tested at 8 time points (10 mins, 20 mins, 30 mins, 60 mins, 120 mins, 180 mins and 240 mins at room temperature, and then at 24 hours after being refrigerated since the last time point) on a Bostwick Consistometer using separate sample for each test.

The utensil consumption methodology entailed inoculating samples with amylase with a spoon by inserting and consuming the product with the spoon. Samples were inoculated every 2 minutes for a 20-minute period. Between each consumption point, the spoon was used to lightly mix the product to ensure any saliva containing amylase was distributed into the product and not retained on the spoon. Viscosity was again tested at 8 time points (10 mins, 20 mins, 30 mins, 60 mins, 120 mins, 180 mins, 240 mins and then at 24 hours after being refrigerated since the last time point) on a Bostwick Consistometer using separate sample for each test.

### Results

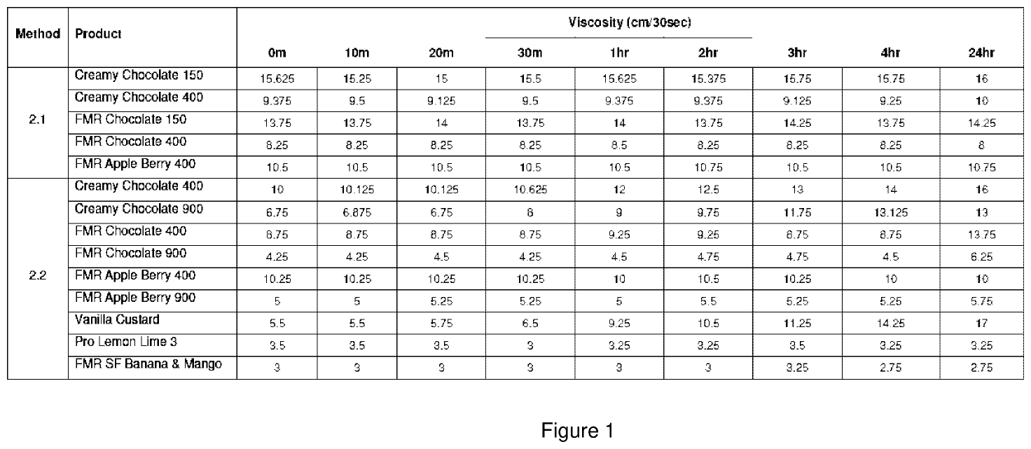

The raw data of the stability studies is presented in the table shown in FIG. 1.

Referring to FIG. 1, nutritional products: apple berry 400, apple berry 900, pro lemon lime, and smooth fruits banana and mango, did not exhibit any viscosity loss when treated under both the direct and utensil consumption methodologies.

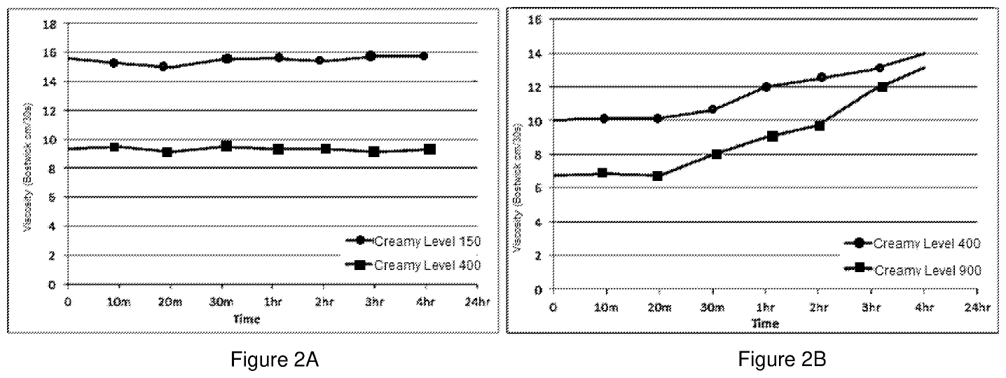

Referring to FIG. 2A, nutritional products: creamy chocolate 150 and creamy chocolate 400, also did not exhibit any change in viscosity when inoculated with the direct consumption methodology.

However, as shown in FIG. 2B, viscosity loss was exhibited in the creamy chocolate 400 and creamy chocolate 900 nutritional products at the 20 minute mark when inoculated with the utensil consumption method.

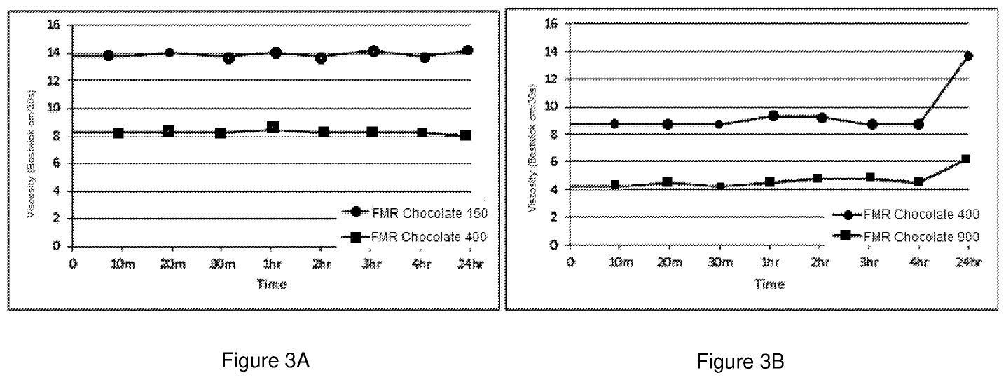

Referring to FIG. 3A, the chocolate 150 and chocolate 400 nutritional products did not exhibit any viscosity loss when inoculated with the direct consumption methodology.

Conversely, and as shown in FIG. 3B, viscosity loss was noted at the 24 hour mark with the chocolate 400 and chocolate 900 nutritional products when inoculated with the utensil consumption method.

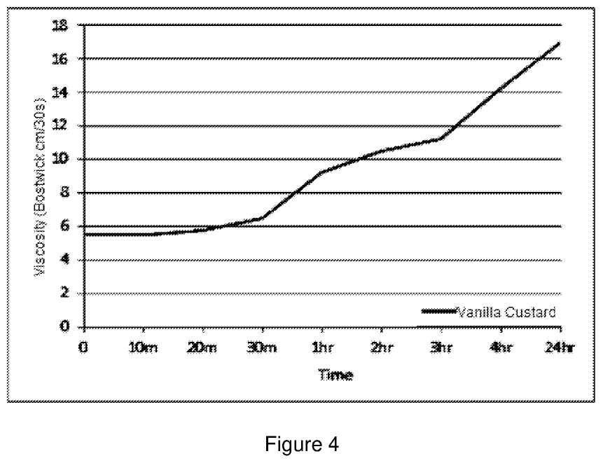

Referring to FIG. 4, the vanilla custard nutritional product exhibited a loss in viscosity at the 30 min mark when inoculated with the utensil consumption methodology.

### Conclusion

Viscosity loss due to amylase contamination appears to be dependent on the matrix of the ingredients contributing to product thickness but also to the severity of the contamination.

Products, such as, apple berry 400, apple berry 900, pro lemon lime, and smooth fruits banana and mango, in which most of the viscosity is provided by fruit and/or xanthan gum (and not starch), were unaffected by amylase activity in the period studied.

Similarly, products, such as, chocolate 150 and chocolate 400 nutritional products, exhibited a reduced affect to amylase activity.

In contrast, nutritional products, such as, creamy chocolate 150, creamy chocolate 400, creamy chocolate 900 and custard, in which starch is the major viscosifier, exhibited a quicker and greater loss of viscosity when inoculated with amylase.

Of the two inoculation methodologies, the utensil consumption methodology was the most effective at inoculating samples. This is hypothesised to be due to the spoon being a more proficient contaminator introducing greater quantities of amylase containing saliva than the direct consumption methodology.

### Example 7: Acacia Gum Studies

Objective—analyse the effect of various ranges of acacia gum on a creamy dairy drink according to the present invention.

Methodology—Five different concentration ranges of acacia gum as shown in the table below were tested utilising temperature, consistency, pH, flow and visual inspection.

| | Acacia | Acacia | Acacia | Acacia | Acacia |
|---|---|---|---|---|---|
| | #1 | #2 | #3 | #4 | #5 |
| Ingredients | (wt. %) | (wt. %) | (wt. %) | (wt. %) | (wt. %) |
| Water | 88.176 | 88.176 | 88.176 | 88.176 | 88.176 |
| Full cream milk | 5.000 | 5.000 | 5.000 | 5.000 | 5.000 |
| powder | | | | | |
| Titanium dioxide | 0.400 | 0.400 | 0.400 | 0.400 | 0.400 |
| Glyceryl mono | 0.200 | 0.200 | 0.200 | 0.200 | 0.200 |
| stearate | | | | | |
| Sodium citrate | 0.150 | 0.150 | 0.150 | 0.150 | 0.150 |
| Calcium caseinate | 2.10 | 2.10 | 2.10 | 2.10 | 2.10 |
| Sugar (white refined) | 3.001 | 3.001 | 3.001 | 3.001 | 3.001 |
| Xanthan gum | 0.520 | 0.520 | 0.520 | 0.520 | 0.520 |
| Acacia gum | 0.00 | 0.10 | 0.15 | 0.20 | 0.25 |
| Tara gum | 0.001 | 0.001 | 0.001 | 0.001 | 0.001 |
| Gellan gum | 0.0075 | 0.0075 | 0.0075 | 0.0075 | 0.0075 |
| Vanilla natural | 0.0075 | 0.0075 | 0.0075 | 0.0075 | 0.0075 |
| flavour | | | | | |
| Antifoam | 0.006 | 0.006 | 0.006 | 0.006 | 0.006 |
| Sodium hydroxide | 0.020 | 0.020 | 0.020 | 0.020 | 0.020 |
| V&M premix | 0.161 | 0.161 | 0.161 | 0.161 | 0.161 |

Each batch was emulsified using a high-shear mixer before being pasteurised at a temperature between 70-75° C. Once pasteurised, each batch was portioned and transferred into a sealed cup before being retorted and processed at 116° C.

The samples were then allowed to equilibrate to ambient temperature (i.e., 22-24° C.) over a 24 hour period.

Following equilibration, the following tests were conducted:
Sample temperature (° C.);
Consistency [viscosity] using a Bostwick Consistometer (cm/30 sec) at ambient temperature;
pH at ambient temperature;
IDDSI Flow test conducted at 4-5° C.; and
Visual inspection using various techniques and looking for evidence of emulsion failure, feathering, separation, curdling splitting or any sign of defect related to gum activity or performance.

### Results

The raw data is presented in the following table.

| | | | | IDDSI | | |
|---|---|---|---|---|---|---|
| | | Bostwick | | refrig- | | |
| | Temp | (cm/30 | | erated | Textural | |
| Sample | (° C.) | sec) | pH | (ml) | Observations | Comments |
| Acacia | 22.3 | 20.5 | 6.99 | 8.0 | Granular, | Surface |
| #1 | | | | | slightly split | feathering |
| Acacia | 23.0 | 20.5 | 6.99 | 7.6 | Grainy | Surface |
| #2 | | | | | | feathering |
| Acacia | 23.5 | 21.0 | 7.00 | 6.8 | Slightly | Surface |
| #3 | | | | | grainy | feathering |
| Acacia | 22.5 | 21.5 | 6.97 | 7.1 | Grainy | Surface |
| #4 | | | | | | feathering |
| Acacia | 22.6 | 20.5 | 6..98 | 6.6 | Faintly | Surface |
| #5 | | | | | grainy | feathering |

### DISCUSSION

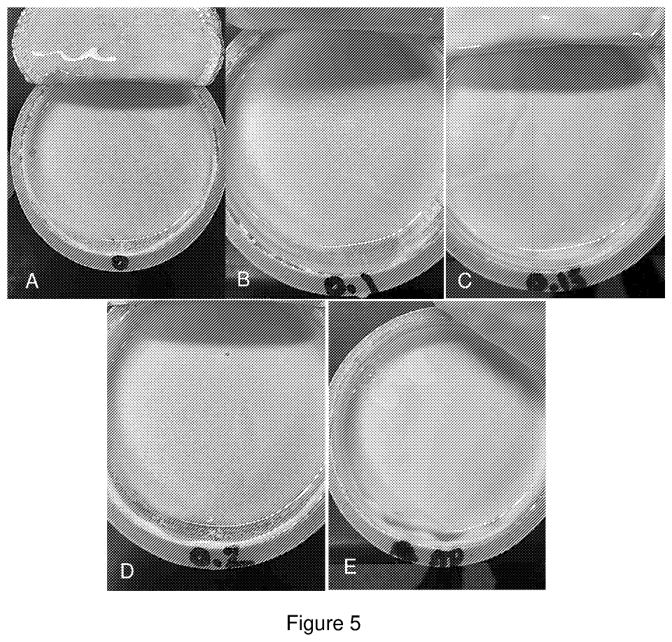

FIGS. 5A to 5E respectively correspond to samples Acacia #1-#5.

It should be noted that whilst assessment tests were conducted at ambient temperature, the IDDSI flow test was performed at refrigeration temperature. This is standard testing procedure to match the requirements of major customers, who generally serve dysphagia ready-to-drink beverages to patients chilled, and so must conform to IDDSI flow test criteria under chilled conditions.

It may have been expected for sample viscosity to increase as the concentration of acacia gum increases. However, these results suggest a slight trend towards the opposite, or at least a more neutral impact on viscosity with increasing acacia gum concentration. This is consistent with previous observations which has led to acacia gum not being used as a thickener due to high concentrations being required to build any significant viscosity.

Rather, acacia gum is more often used for its emulsifying properties. The emulsifying effect of acacia gum can be seen in these results, particularly in the IDDSI results wherein an increasing concentration of acacia gum is associated with higher flow rates through the syringe test and apparent lower viscosity. As acacia gum concentration increases, providing increased emulsification and support to milk proteins, there is reduced protein destabilisation, with less granular, smoother texture and enhanced flow properties resulting—see FIG. 5E.

There was no significant difference observed in pH across samples. Particularly useful as an indicator of batch preparation and processing quality, pH results provide a degree of confidence that all batches were prepared correctly, without error, and not exposed to unexpected delays in processing. It is also a useful indicator of the likely absence of microbial activity, which may lead to fermentation and spoilage.

Referring to FIGS. 5A-E, it can be observed that there are many white streaks present on the upper surface of the samples. This is often internally referred to as feathering. Feathering has been previously thought to be a factor of protein instability. It is currently thought that this is likely not the case and the feathering is more likely a result of product surface foam and/or product inversion during processing, giving rise to visible traces of titanium dioxide sediment. The cups are inverted after sealing and are processed through the retort in an inverted position. As such, the titanium dioxide suspension within the product is supported by the gum systems, which melt or partially melt during the retorting process, and then re-set upon cooling. This temporary melting of the gums provides a window of reduced suspension properties, allowing a small portion of titanium dioxide to settle to the bottom of the inverted cup. When later returned to an upright position, the sediment now appears at the upper surface of the product and becomes obvious under visual inspection when opening the cup.

### Conclusion

The results indicate that acacia gum provides beneficial emulsifying effects when used in the creamy dairy drink. The emulsifying effect was observed to increase with increasing concentrations of acacia gum—compare FIG. 5A with FIG. 5E. From this experiment, the inclusion of acacia gum at a concentration of about 0.25% provided the best outcome, with benefit and improvement in product texture observed at concentration levels as low as 0.1%.

### Example 8: Expanded Acacia Gum Studies

Objective—analyse the effect of expanded concentration ranges of acacia gum on a creamy dairy drink according to the present invention.

Methodology—Nine different concentration ranges of acacia gum as shown in the table below were tested utilising temperature, consistency, pH, flow and visual inspection.

| | Acacia | Acacia | Acacia | Acacia | Acacia | Acacia | Acacia | Acacia | Acacia |
|---|---|---|---|---|---|---|---|---|---|
| | #2.1 | #2.2 | #2.3 | #2.4 | #2.5 | #2.6 | #2.7 | #2.8 | #2.9 |
| Ingredients | (wt. %) | (wt. %) | (wt. %) | (wt. %) | (wt. %) | (wt. %) | (wt. %) | (wt. %) | (wt. %) |
| Water | 88.176 | 88.176 | 88.176 | 88.176 | 88.176 | 88.176 | 88.176 | 88.176 | 88.176 |
| Full cream | 5.000 | 5.000 | 5.000 | 5.000 | 5.000 | 5.000 | 5.000 | 5.000 | 5.000 |
| milk powder | | | | | | | | | |
| Titanium | 0.400 | 0.400 | 0.400 | 0.400 | 0.400 | 0.400 | 0.400 | 0.400 | 0.400 |
| dioxide | | | | | | | | | |
| Glyceryl | 0.200 | 0.200 | 0.200 | 0.200 | 0.200 | 0.200 | 0.200 | 0.200 | 0.200 |
| monostearate | | | | | | | | | |
| Sodium | 0.150 | 0.150 | 0.150 | 0.150 | 0.150 | 0.150 | 0.150 | 0.150 | 0.150 |
| citrate | | | | | | | | | |
| Calcium | 2.10 | 2.10 | 2.10 | 2.10 | 2.10 | 2.10 | 2.10 | 2.10 | 2.10 |
| caseinate | | | | | | | | | |
| Sugar (white | 3.001 | 3.001 | 3.001 | 3.001 | 3.001 | 3.001 | 3.001 | 3.001 | 3.001 |
| refined) | | | | | | | | | |
| Xanthan gum | 0.520 | 0.520 | 0.520 | 0.520 | 0.520 | 0.520 | 0.520 | 0.520 | 0.520 |
| Acacia gum | 0.00 | 0.10 | 0.15 | 0.20 | 0.25 | 0.30 | 0.35 | 0.40 | 0.50 |
| Tara gum | 0.001 | 0.001 | 0.001 | 0.001 | 0.001 | 0.001 | 0.001 | 0.001 | 0.001 |
| Gellan gum | 0.0075 | 0.0075 | 0.0075 | 0.0075 | 0.0075 | 0.0075 | 0.0075 | 0.0075 | 0.0075 |
| Vanilla | 0.0075 | 0.0075 | 0.0075 | 0.0075 | 0.0075 | 0.0075 | 0.0075 | 0.0075 | 0.0075 |
| natural | | | | | | | | | |
| flavour | | | | | | | | | |
| Antifoam | 0.006 | 0.006 | 0.006 | 0.006 | 0.006 | 0.006 | 0.006 | 0.006 | 0.006 |
| Sodium | 0.020 | 0.020 | 0.020 | 0.020 | 0.020 | 0.020 | 0.020 | 0.020 | 0.020 |
| hydroxide | | | | | | | | | |
| V&M premix | 0.161 | 0.161 | 0.161 | 0.161 | 0.161 | 0.161 | 0.161 | 0.161 | 0.161 |

Each batch was emulsified using a high-shear mixer before being pasteurised at a temperature between 70-75° C. Once pasteurised, each batch was portioned and transferred into a sealed cup before being retorted and processed at 116° C.

The samples were then allowed to equilibrate to ambient temperature (i.e., 22-24° C.) over a 24 hour period.

Following equilibration, the following tests were conducted:
Sample temperature (° C.);
Consistency [viscosity] using a Bostwick Consistometer (cm/30 sec) at ambient temperature;
pH at ambient temperature;
IDDSI Flow test conducted at 4-5° C.; and
Visual inspection using various techniques and looking for evidence of emulsion failure, feathering, separation, curdling splitting or any sign of defect related to gum activity or performance.

### Results

The raw data is presented in the following table.

| | | | | IDDSI | | |
|---|---|---|---|---|---|---|
| | | Bostwick | | refrig- | | |
| | Temp | (cm/30 | | erated | Textural | |
| Sample | (° C.) | sec) | pH | (ml) | Observations | Comments |
| Acacia | 22.7 | 20.75 | 7.21 | 5.0 | Granular, | Surface |
| #2.1 | | | | | slightly split | feathering |
| Acacia | 23.1 | 20.25 | 7.22 | 5.0 | Grainy | Surface |
| #2.2 | | | | | | feathering |
| Acacia | 23.1 | 20.50 | 7.21 | 5.6 | Sightly | Surface |
| #2.3 | | | | | grainy | feathering |
| Acacia | 22.7 | 21.00 | 7.32 | 4.4 | Grainy | Surface |
| #2.4 | | | | | | feathering |
| Acacia | 22.9 | 21.00 | 7.33 | 4.2 | Faintly | Surface |
| #2.5 | | | | | grainy | feathering |
| Acacia | 23.0 | 20.25 | 7.35 | 5.0 | Faintly | Surface |
| #2.6 | | | | | grainy | feathering |
| Acacia | 22.8 | 20.50 | 7.27 | 5.5 | Slightly | Surface |
| #2.7 | | | | | grainy | feathering |
| Acacia | 23.2 | 20.00 | 7.37 | 5.2 | Faintly | Surface |
| #2.8 | | | | | grainy | feathering |
| Acacia | 23.3 | 20.00 | 7.38 | 6.0 | Faintly | Surface |
| #2.9 | | | | | grainy | feathering |

### Discussion

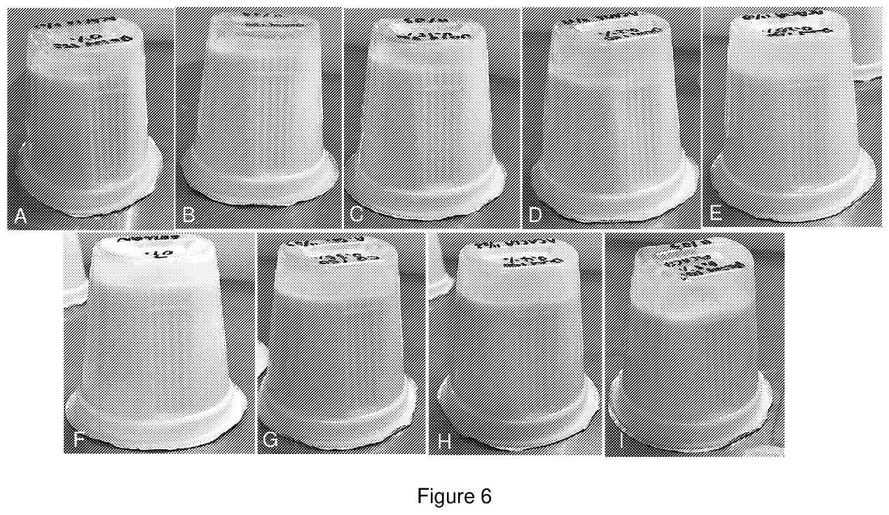

FIGS. 6A to 61 respectively correspond to samples Acacia #2.1-#2.9.

The results for the Bostwick and IDDSI flow test suggest a trend toward reduction in viscosity with increase flow properties with increasing acacia gum concentration up to 0.25% acacia gum. Above 0.25%, the trend appears to reverse with increasing Bostwick and reduced IDDSO flow test results.

The viscosity results for samples up to 0.25% acacia gum are consistent with the results from Example 7. This provide confidence that the results observed are valid and reproducible. These are also consistent observations using acacia gum in wider applications where in general acacia gum is not used as a thickener due to the high concentrations required to build any significant viscosity. Rather, acacia gum has been more often used for its emulsifying properties. The emulsify effect of acacia gum can be seen in these results, particularly in the IDDSI results where an increasing concentration of acacia gum is associated with higher flow rates through the syringe test and apparent lower viscosity. As acacia gum concertation increases, providing increased emulsification and support to the milk protein, there is a reduction in protein destabilisation, with less granular, smoother texture and enhanced flow properties resulting.

The observation of an apparent reversal of viscosity trend at levels above 0.25% suggest that there may be no increased benefit to be gained by the addition of acacia gum above 0.25% in the composition of the present invention. This seems to indicate that 0.25% may be the optimal addition rate of acacia gum in dysphagia ready-to-drink beverages.

There was no significant difference observed in pH between samples. Again, this is particularly useful as an indicator of batch preparation and processing quality, pH results providing a degree of confidence that all batches were prepared correctly, without error, and not exposed to unexpected delays in processing. It is also a useful indicator of the likely absence of microbial activity, which may lead to fermentation and spoilage.

Product texture assessment results found the 0.00% acacia gum sample to be very granular/grainy in texture with possibly having a slightly split or broken emulsion—see FIG. 6A. With increasing acacia gym concentration graininess appears to reduce up to 0.25% acacia gum—see FIG. 6E. Above 0.25%, no significant further improvement appears to occur—see FIGS. 6F-61.

Other observations showed that all samples had some degree of white streaks present on the upper surface of the samples. This is referred to as feathering. The feathering is thought to result from product surface form and/or product inversion during processing, which give rise to visible traces of titanium dioxide sediment as commented on in Experiment 7.

### Conclusion

These results indicate that acacia gum provide beneficial emulsifying effects when used in dysphagia ready-to-drink formulated beverages. The emulsifying effect was observed to increase with increasing concentrations of acacia gum up to 0.25%. Further increases in concentration above 0.25% resulted in no additional benefit, suggesting optimal addition rate of acacia gum in this study to be 0.25%. Benefits and improvement in sample texture were observed at concentrations as low as 0.1%.

### Example 9: Gellan Gum Studies

Objective—analyse the effect of various ranges of gellan gum on a creamy dairy drink according to the present invention.

Methodology—Four different concentration ranges of gellan gum as shown in the table below were tested utilising temperature, consistency, pH, flow and visual inspection.

| | Gellan #1 | Gellan #2 | Gellan #3 | Gellan #4 |
|---|---|---|---|---|
| Ingredients | (wt. %) | (wt. %) | (wt. %) | (wt. %) |
| Water | 88.176 | 88.176 | 88.176 | 88.176 |
| Full cream milk | 5.000 | 5.000 | 5.000 | 5.000 |
| powder | | | | |
| Titanium dioxide | 0.400 | 0.400 | 0.400 | 0.400 |
| Glyceryl mono | 0.200 | 0.200 | 0.200 | 0.200 |
| stearate | | | | |
| Sodium citrate | 0.150 | 0.150 | 0.150 | 0.150 |
| Calcium caseinate | 2.10 | 2.10 | 2.10 | 2.10 |
| Sugar (white refined) | 3.001 | 3.001 | 3.001 | 3.001 |
| Xanthan gum | 0.520 | 0.520 | 0.520 | 0.520 |
| Acacia gum | 0.25 | 0.25 | 0.25 | 0.25 |
| Tara gum | 0.001 | 0.001 | 0.001 | 0.001 |
| Gellan gum | 0.000 | 0.0025 | 0.005 | 0.0075 |
| Vanilla natural | 0.0075 | 0.0075 | 0.0075 | 0.0075 |
| flavour | | | | |
| Antifoam | 0.006 | 0.006 | 0.006 | 0.006 |
| Sodium hydroxide | 0.020 | 0.020 | 0.020 | 0.020 |
| V&M premix | 0.161 | 0.161 | 0.161 | 0.161 |

Each batch was emulsified using a high-shear mixer before being pasteurised at a temperature between 70-75° C. Once pasteurised, each batch was portioned and transferred into a sealed cup before being retorted and processed at 116° C.

The samples were then allowed to equilibrate to ambient temperature (i.e., 22-24° C.) over a 24 hour period.

Following equilibration, the following tests were conducted:
Sample temperature (° C.);
Consistency [viscosity] using a Bostwick Consistometer (cm/30 sec) at ambient temperature;
pH at ambient temperature;
IDDSI Flow test conducted at 4-5° C.; and
Visual inspection using various techniques and looking for evidence of emulsion failure, feathering, separation, curdling splitting or any sign of defect related to gum activity or performance.

### Results

The raw data is presented in the following table.

| | | | | IDDSI | | |
|---|---|---|---|---|---|---|
| | | Bostwick | | refrig- | | |
| | Temp | (cm/30 | | erated | Textural | |
| Sample | (° C.) | sec) | pH | (ml) | Observations | Comments |
| Gellan | 23.2 | 20.50 | 6.93 | 5.0 | Granular, split | Surface |
| #1 | | | | | | feathering |
| Gellan | 23.1 | 21.00 | 7.19 | 5.2 | Granular, split | Surface |
| #2 | | | | | | feathering |
| Gellan | 23.1 | 20.50 | 7.26 | 4.6 | Slightly grainy | Some |
| #3 | | | | | | feathering |
| Gellan | 22.9 | 21.00 | 7.33 | 4.2 | Smooth, even | Very little |
| #4 | | | | | flowing | feathering |

### Discussion

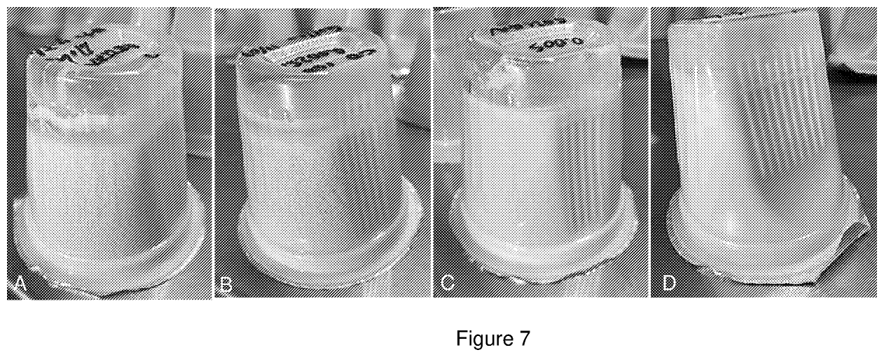

FIGS. 7A to 7D respectively correspond to samples Gellan #1-#4.

Referring to FIGS. 7A to D, the results for the Bostwick indicate no significant change across the range of gellan gum concentrations.

However, the IDDS flow test shows a trend of increasing flow properties with increasing gum addition. This is an attribute previously observed in other gum studies conducted in this series (notably with acacia gum) and in the case of gellan gum appears to relate to a reduction of protein coagulation and destabilisation with increasing gum addition. With reduced protein coagulation, samples appear to be smoother, more homogenous and less granular, split and broken. The smoother more homogenous textures provide better flow properties and therefore higher flow through the syringe during the IDDS flow testing.

It is also observed that the combination of gums used contributes to this principle, likely through slightly differing mechanisms, yet in combination provide an enhanced outcome that could not be achieved by use of these gums in isolation.

There was no significant difference observed in pH between samples. However, a slight trend of increasing pH with increasing gellan gum addition can be observed. As previously mentioned, pH can be a useful indicator of batch preparation and processing quality. In this instance, the pH values provide a degree of confidence that all batches were prepared correctly, without error, and not exposed to unexpected delays in processing. It is also a useful indicator of the likely absence of microbial activity, which may otherwise lead to fermentation or spoilage.

Product texture assessment results found the 0.00% gellan gum sample to be noticeable granular/grainy in texture appearing to have a split or broken emulsion—see FIG. 7A. The 0.0025% sample did not appear to be must better—see FIG. 7B. An observable improvement was noted with the 0.005% sample (see FIG. 7C), and a further improvement was observed in the 0.0075% sample, which clearly had the best texture—see FIG. 7D. With increasing gellan gum concentration, graininess appears to reduce, and a smoother, more homogenous flowing texture is observed. This suggests gellan gum is providing protection and support to the milk proteins against destabilisation and coagulation during the high-heat conditions of the retort process.

Other observations showed that all samples had some degree of white streaks present on the upper surface of the samples. The streaking was observed to decrease with increasing concentrations of gellan gum. This is referred to as “feathering”. The feathering is thought to result from product surface form and/or product inversion during processing, which give rise to visible traces of titanium dioxide sediment as commented on in Experiment 7.

### Conclusion

These results indicate that gellan gum provides beneficial protection and support to milk protein during high-heat treatment, such as found in the retort process as used in dysphagia ready-to-drink formulated beverages. The beneficial effects were observed to increase with increasing concentrations of gellan gum up to 0.0075%. Benefit and improvement in product texture was observed at gellan gum concentration levels as low as 0.005%.

1. A composition for thickening a nutritional product to make the product suitable for consumption by dysphagia patients, said composition including comprising by weight % of a ready to consume said product:
between about 0.1% to about 3.0% of xanthan gum;
between about 0.1% to about 1.0% of acacia gum; and
between about 0.001% to about 0.01% of gellan gum,
wherein the composition is substantially free of starch.

2. The composition of claim 1, further comprising between about 0.001% to about 0.01% tara gum.

3. The composition of claim 2, wherein the composition comprises between about 0.1% to about 2.5% xanthan gum.

4. The composition of any one of claim 3, wherein the composition comprises between about 0.2% to about 2.0% xanthan gum.

5. The composition of claim 4, wherein the composition comprises between about 0.1% acacia gum to about 0.5% acacia gum.

6. The composition of claim 5, wherein the composition comprises about 0.25% acacia gum.

7. The composition of claim 1, wherein the composition comprises between about 0.001% to about 0.01% gellan gum.

8. The composition of claim 7, wherein the composition comprises between about 0.005% to about 0.0075% high acyl gellan gum.

9. The composition of claim 8, wherein the composition comprises between about 0.001% to about 0.005% tara gum.

10. The composition of claim 9, wherein the composition comprises about 0.001% to about 0.003% tara gum.

11. The composition of claim 1, further comprises between about 0.001% to about 0.75% locust bean gum.

12. The composition of claim 1, further comprises between about 0.001% to about 0.75% guar gum.

13. The composition of claim 1, wherein the composition is formulated to be added to the nutritional product.

14. The composition of claim 1, wherein the composition further comprises the nutritional product.

15. The composition of claim 1, wherein the composition is formulated in a ready to consume form.

16. A thickened nutritional product comprises the composition of claim 1, wherein the thickened nutritional product is substantially free of starch.

17. A method of preparing a thickened nutritional product for consumption by dysphagia patients, said method comprises:
mixing the composition according to claim 1 with a nutritional product to obtain the thickened nutritional product, wherein the thickened nutritional product is substantially unsusceptible to starch degradation by amylase.

18. The method of claim 17, wherein the mixing comprises at least one of cooking, blending, and emulsifying the composition and the nutritional product together to obtain the thickened nutritional product.

19. The method of claim 17, further comprises at least one of pressure cooking and pasteurising the thickened nutritional product.

20. (canceled)

21. A method of treating dysphagia comprises administering a composition according to claim 1 and a nutritional product to a patient in need thereof, wherein the composition and the nutritional product are substantially free of starch.
